(19) United States
(12) Patent Application Publication
(10) Pub. No.: US 2008/0077667 A1
(43) Pub. Date: Mar. 27, 2008

(54) METHOD FOR ADAPTIVE GROUP SCHEDULING USING MOBILE AGENTS IN PEER-TO-PEER GRID COMPUTING ENVIRONMENT

(76) Inventors: Chong-Sun Hwang, Seoul (KR); Sung-Jin Choi, Seoul (KR); Hong-Soo Kim, Seoul (KR); Eun-Joung Byun, Seoul (KR); Seok-In Kim, Seoul (KR); Soo-Jin Koo, Seoul (KR)

Correspondence Address: SHERR & NOURSE, PLLC, 620 HERNDON PARKWAY, SUITE 200, HERNDON, VA, 20170, US

(21) Appl. No.: 11/535,159

(22) Filed: Sep. 26, 2006

(51) Int. Cl. G06F 15/16

(52) U.S. Cl. 709/205; 709/204

(57) ABSTRACT

Embodiments of the present invention relates to mobile agent technology which includes a scheduling mechanism adaptive to dynamic peer-to-peer grid computing environments. A mobile agent is a software program that migrates from one node to another while performing various tasks on behalf of a user.

### FIELD OF THE INVENTION

The present invention generally relates to grid computing systems and in particular to adaptive group scheduling method using mobile agents in peer-to-peer grid computing.

### BACKGROUND OF THE INVENTION

A grid computing system is a platform that provides access to various computing resources owned by institutions by creating a virtual organization. On the other hand, a peer-to-peer grid computing system is a platform that achieves high throughput computing by harvesting a number of idle desktop computers owned by individuals (called volunteers) on the edge of the Internet using peer-to-peer computing technologies. The peer-to-peer grid computing systems usually support embarrassingly parallel applications, consisting of numerous instances of the same computation with its own data. The applications are usually involved with scientific problems that require large amounts of sustained processing capacity over long periods of time.

As shown in FIG. 1, a peer-to-peer grid computing environment mainly consists of clients, volunteers, and volunteer servers. A client is a parallel job submitter. A volunteer is a resource provider that donates its computing resources when idle. A volunteer server is a central manager that controls submitted jobs and volunteers. A client submits a parallel job to a volunteer server. The job is divided into sub-jobs that have their own specific input data.

The sub-job is called a task. A task consists of parallel code and data. The volunteer server allocates tasks to volunteers using scheduling mechanisms. Each volunteer executes its task when idle, while continuously requesting data from the volunteer server. When each volunteer subsequently finishes the task, it returns the result of the task to the volunteer server. Finally, the volunteer server returns the final result of the job back to the client.

A peer-to-peer grid computing is complicated by heterogeneous capabilities, failures, volatility (i.e., intermittent presence), and lack of trust because it is based on desktop computers (i.e., volunteers) at the edge of the Internet. Volunteers have various capabilities (i.e., CPU, memory, network bandwidth, and latency), and are exposed to link and crash failures. In particular, they are voluntary participants that do not receive any reward for donating their resources. As a result, they are free to join and leave in the middle of execution without any constraints. Accordingly, they have various volunteering times (i.e., the time of donation), and public execution (i.e., the execution of a task as a volunteer) can be stopped arbitrarily on account of unexpected leave. Moreover, public execution is temporarily suspended by private execution (i.e., the execution of a private job as a personal user) because volunteers are not totally dedicated to public executions.

These unstable situations are regarded as volunteer autonomy failures because they lead to the delay and blocking of the execution of tasks and include situations resulting in the partial or entire loss of the executions. Volunteers have different occurrence rates for volunteer autonomy failures according to their execution behavior. In addition, some malicious volunteers may tamper with the computation and return corrupt results. These distinct features make it difficult for a volunteer server to schedule tasks and manage allocated tasks and volunteers.

In order to improve the reliability of computation and performance in a peer-to-peer grid computing environment, a scheduling mechanism must adapt to the distinct features which result from the heterogeneous properties and volatility of volunteers. To achieve this, a scheduling mechanism is required to classify volunteers into groups that have similar properties (especially, volunteer autonomy failures), and subsequently dynamically apply various scheduling mechanisms, fault tolerance, and replication algorithms to each group.

Existing peer-to-peer grid computing systems, however, do not provide a scheduling mechanism on a per group basis. In addition, only the volunteer server performs the scheduling mechanism in a centralized way. As a result, existing mechanisms suffer from a high overhead of the computation and volunteer server, and cause performance degradation.

### SUMMARY OF THE INVENTION

In the present invention, mobile agent technology is exploited to make the scheduling mechanism adaptive to dynamic peer-to-peer grid computing environments.

A mobile agent is a software program that migrates from one node to another while performing various tasks on behalf of a user. A mobile agent includes benefits as follows.

1) A mobile agent can reduce network load and latency by dispatching the mobile agents that include the required services and data to remote nodes. Then, the services or data are locally executed at the remote nodes.

2) A mobile agent can solve frequent and intermittent disconnection. Once a mobile agent is dispatched to a destination node, it does not require direct connection with a user anymore. Therefore, the mobile agent on behalf of a user operates asynchronously and autonomously, even though a user (i.e., mobile device) may be disconnected from the network.

3) A mobile agent enables dynamic service customization and software deployment because it encapsulates some services or protocols into its mobility entity.

4) A mobile agent can adapt to heterogeneous environments and dynamic changes because it is computer- and transport-independent and reacts autonomously according to its current execution environment.

There are some advantages of making use of mobile agents in peer-to-peer grid computing environments.

1) Various scheduling mechanisms can be performed at a time according to the properties of volunteers. For example, these scheduling mechanisms can be implemented as mobile agents (i.e., scheduling mobile agents). After volunteers are classified into volunteer groups, the most suitable scheduling mobile agent for a specific volunteer group is assigned to the volunteer group according to its property. Existing peer-to-peer grid computing systems, however, cannot apply various scheduling mechanisms because only one scheduling mechanism is performed by a volunteer server in a centralized way.

2) A mobile agent can decrease the overhead of volunteer server by performing scheduling, fault tolerance, and replication algorithms in a decentralized way. The scheduling mobile agents are distributed to volunteer groups. Then, they autonomously conduct scheduling, fault tolerance, and replication algorithms in each volunteer group without direct control of a volunteer server. Accordingly, the volunteer server does not further undergo the overhead.

3) A mobile agent can adapt to dynamical peer-to-peer grid computing environments. In a peer-to-peer grid computing environment, volunteers can join and leave at any time. In addition, they are characterized by heterogeneous properties such as capabilities (i.e., CPU, storage, or network bandwidth), location, availability, credibility, and so on. These environmental properties change over time. A mobile agent can perform asynchronously and autonomously, while coping with the changes. Volunteer autonomy failures can also be tolerated by using migration and replication functionalities that the mobile agent itself provides.

### BRIEF DESCRIPTION OF THE DRAWINGS

FIG. 1 shows peer-to-peer grid computing environment.

FIG. 2 shows existing peer-to-peer grid computing model.

FIG. 3 shows mobile agent based peer-to-peer grid computing model.

FIG. 4 shows the classification criteria of volunteers.

FIG. 5 shows the classification of volunteers.

FIG. 6 shows the classification of volunteer groups.

FIG. 7 shows algorithm of volunteer group construction.

FIG. 8 shows algorithm of deputy volunteer selection.

FIG. 9 shows the concept of parallel and sequential distribution.

FIG. 10 shows fault tolerant algorithm in the presence of failures of S-MA.

FIG. 11 shows fault tolerant algorithm in the presence of failures of T-MA.

FIG. 12 shows fault tolerant algorithm in the presence of failures of T-MA.

FIG. 13 shows fault tolerant algorithm in the presence of failures of T-MA.

FIG. 14 shows screen shots of Korea@Home.

FIG. 15 shows performance trace in which (a) is daily performance and (b) is hourly performance.

FIG. 16 shows CPU types of volunteers in Korea@Home.

FIG. 17 is a graph showing the average number of completed tasks.

FIG. 18 is a graph showing the average number of completed tasks in the case of replication in Case 2.

FIG. 19 is a graph showing the average number of redundancy in Case 2.

FIG. 20 is a graph showing the average number of completed tasks in case of replication (reliability threshold=0.8).

FIG. 21 shows the average number of redundancy in each case.

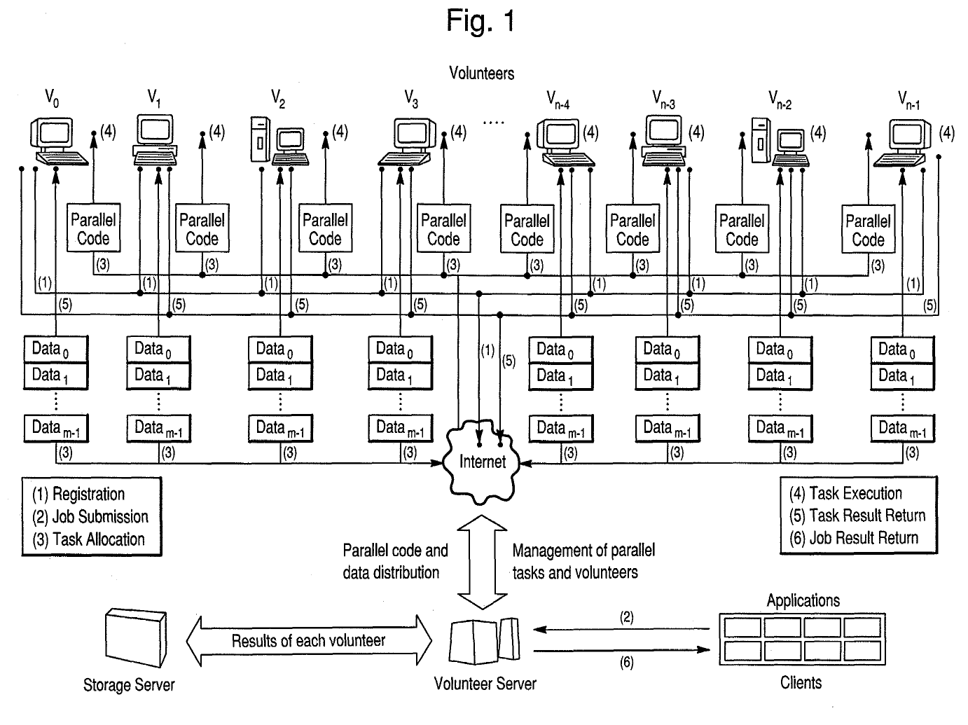

### DETAILED DESCRIPTION OF THE INVENTION

### 1. System Model

### 1.1. Existing Peer-to-Peer Grid Computing Model

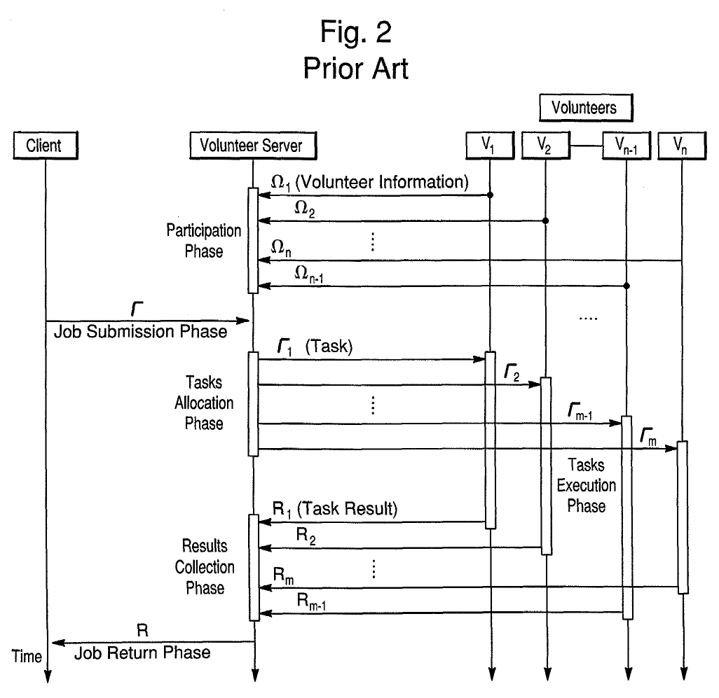

As shown in FIG. 2, the execution model of peer-to-peer grid computing consists of six phases: registration, job submission, task allocation, task execution, task result return, and job result return phase.
Registration phase: Volunteers register their information to a volunteer server
Job submission phase: A client consigns a job to a volunteer server.
Task allocation phase: A volunteer server distributes tasks to the registered volunteers using a scheduling mechanism.
Task execution phase: The volunteers execute each task.
Task result return phase: Each volunteer returns the result of its task to the volunteer server.
Job result return phase: The volunteer server returns the final result of the job to the client.

In FIG. 2, a volunteer Vᵢ (0≦i≦n) register volunteering information Ωᵢ (i.e., computing resources properties) to a volunteer server and participate in the execution of tasks. If a client consigns a job Γ to a volunteer server, the volunteer server allocates the tasks Γₘ to volunteers. The volunteer Vᵢ executes the task Γₘ and then returns a result Rₘ of execution of the task Γₘ to its volunteer server. The volunteer server returns the final result R of the consigned job Γ to the client.

### 1.2. Mobile Agent Based Peer-to-Peer Grid Computing Model

A mobile agent is a software program that migrates from one node to another while performing various tasks on behalf of a user. A mobile agent can adapt to dynamic environmental changes as well as various properties of volunteers. In addition, since mobile agents are executed in a distributed way, the overhead of volunteer server can be reduced. Therefore, we propose an overall execution model in which mobile agents are applied to a peer-to-peer grid computing.

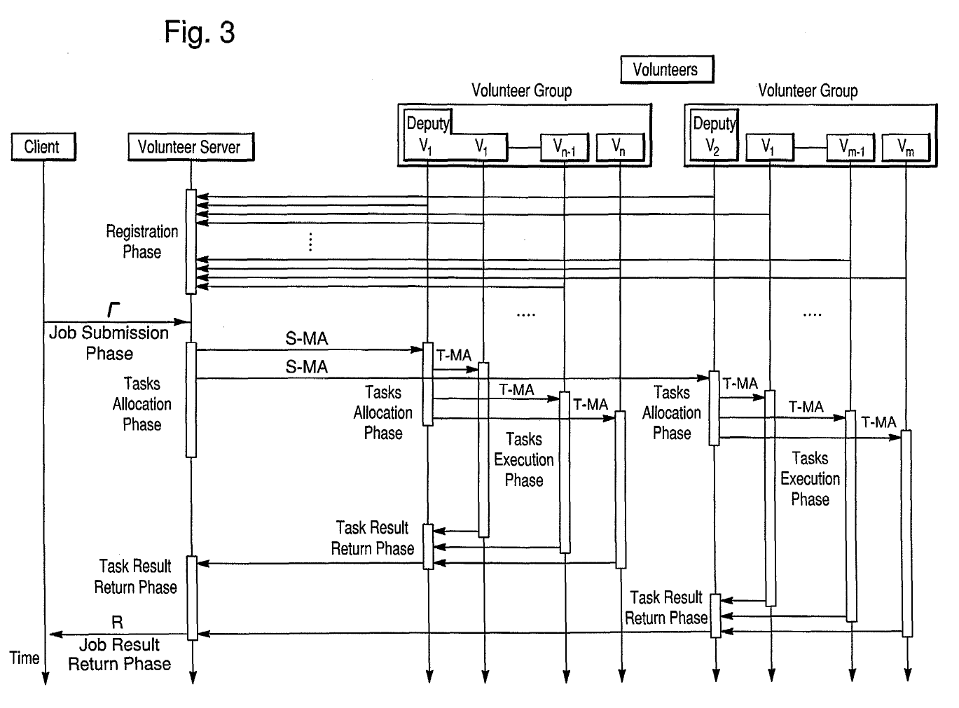

Mobile agent based peer-to-peer grid computing works similar to the execution model of existing peer-to-peer grid computing. Several phases, however, operate differently (see FIG. 3). In the registration phase, volunteers register basic properties such as CPU, memory, OS type as well as additional properties including volunteering time, volunteering service time, volunteer availability, volunteer autonomy failures, volunteer credibility, and so on. In particular, since these additional properties are related to dynamical computation and execution, they are more important than basic properties.

In the job submission phase, the submitted job is divided into a number of tasks. The tasks are implemented as mobile agents (i.e., task mobile agents: T-MA).

In the task allocation phase, the volunteer server does not perform the entire scheduling mechanism anymore. Instead, it helps scheduling mobile agents (S-MA) to perform a scheduling procedure. Initially, the volunteer server classifies and constructs the volunteer groups according to properties such as location, volunteer autonomy failures, volunteering service time, and volunteer availability. Next, scheduling mobile agents are distributed to volunteer groups according to their properties. Finally, the scheduling mobile agent distributes task mobile agents to the members of its volunteer group.

In the task execution phase, the task mobile agent is executed in cooperation with its scheduling mobile agent while migrating to another volunteer or replicating itself in the presence of failures.

In the task result return phase, the task mobile agent returns each result to its scheduling mobile agent. When all task mobile agents return their results, the scheduling mobile agent aggregates the results and then returns the collected results to the volunteer server. In order to tolerate erroneous results, majority voting and spot-checking mechanisms are conducted in cooperation with the volunteer server.

In the job result return phase, the volunteer server returns a final result to the client when it receives all the results from the scheduling mobile agents.

To summarize briefly, the main differences between the existing execution model and new model are as follows. 1) The new mobile agent based peer-to-peer grid computing model uses scheduling and task mobile agents. 2) It uses volunteer groups that are constructed according to dynamic properties of volunteers such as volunteer autonomy failures, volunteering service time, availability, and credibility. 3) Various scheduling, fault tolerance, and replication algorithms are performed simultaneously in a decentralized way.

### 1.3. Failure Model

In peer-to-peer grid computing environments, volunteers are connected through the Internet, and therefore are exposed to crash and link failures. In addition, since peer-to-peer grid computing is based on voluntary participants, the autonomy of volunteers is respected. In other words, volunteers can leave arbitrarily in the middle of public execution and are allowed to interrupt public execution at any time for private execution. In a peer-to-peer grid computing environment, volunteer autonomy failures occur much more frequently than crash and link failures. Therefore, volunteer autonomy failures should specially be dealt with, while they are distinguished from traditional failures. Moreover, volunteers have various occurrence rates and types of volunteer autonomy failures. Since the heterogeneous occurrence rates and types of volunteer autonomy failures affect computation directly, a scheduling mechanism must take them into account in order to obtain better performance and guarantee reliable computation. To this end, volunteer autonomy failures are first defined conceptually.

In order to clarify definition of volunteer autonomy failures, the notations in Table 1 are used. First, the join and leave patterns of a volunteer are categorized. The patterns are categorized into expected join (EJ), expected leave (EL), unexpected join (UJ), and unexpected leave (UL).

TABLE 1
Notations

| | |
|---|---|
| Vᵢ | A Volunteer (0 ≦ i ≦ n) |
| Γₘ | A task performed by a volunteer |
| ξᵢ | Public execution of a task Γₘ at Vᵢ |
| I_{ξi} | Time interval of public execution ξᵢ |
| [symbol] | Volunteering time which is the period when a volunteer is |
| | supposed to provide its resources |
| [symbol] ₛₜ | The start time when a volunteer Vᵢ is supposed to provide |
| | its resources |
| [symbol] ₜₜ | The termination time when a volunteer Vᵢ is |
| | supposed to provide its resources |
| Vᵢ [symbol] ξᵢ | The join event which a volunteer Vᵢ participates |
| | in public execution ξᵢ |
| Vᵢ [symbol] ξᵢ | The leave event which a volunteer Vᵢ leaves public |
| | execution ξᵢ |
| T[Vᵢ [symbol] ξᵢ] | The time when Vᵢ [symbol] ξᵢ happens |
| Πᵢ | An individual job which is performed by a personal |
| | user at Vᵢ |
| πᵢ | Private execution of a individual job Πᵢ |
| [symbol] | The symbol means ”occurs when” |

EJ [symbol] (T[_{V}_{ᵢ} [symbol] _{ξ}_{ᵢ}]=Vᵢ. [symbol] ₛₜ)

EL [symbol] (T[_{V}_{ᵢ} [symbol] _{ξ}_{ᵢ}]=Vᵢ. [symbol] ₜₜ)

UJ [symbol] ((T[_{V}_{ᵢ} [symbol] _{ξ}_{ᵢ}]≠Vᵢ. [symbol] ₛₜ)

UL [symbol] (T[_{V}_{ᵢ} [symbol] _{ξ}_{ᵢ}]≠Vᵢ. [symbol] ₜₜ)

UJ is categorized into before-unexpected-join UJ^{b}, middle-unexpected-join UJ^{m}, and after-unexpected-join UJ^{a}. In addition, unexpected-leave UL is categorized into before-unexpected-leave UL^{b}, middle-unexpected-leave UL^{m}, and after unexpected-leave UL^{a}.

UJ={UJ^{b}, UJ^{m}, UJ^{a}}

UJ^{b} [symbol] (T[_{V}_{ᵢ} [symbol] _{ξi}]<Vᵢ. [symbol] ₜₜ)

UJ^{m} [symbol] (Vᵢ. [symbol] ₛₜ<T[_{V}_{ᵢ} [symbol] _{ξ}_{ᵢ}]<Vᵢ. [symbol] ₜₜ)

UJ^{a} [symbol] (Vᵢ. [symbol] ₜₜ<T[_{V}_{ᵢ} [symbol] _{ξ}_{ᵢ}])

UL={UL^{b}, UL^{m}, UL^{a}}

UL^{b} [symbol] (T[_{V}_{ᵢ} [symbol] _{ξ}_{ᵢ}]<Vᵢ. [symbol] ₛₜ)

UL^{m} [symbol] (Vᵢ. [symbol] ₛₜ<T[_{V}_{ᵢ} [symbol] _{ξ}_{ᵢ}]<Vᵢ. [symbol] ₜₜ)

UL^{a} [symbol] (Vᵢ. [symbol] ₜₜ<T[_{V}_{ᵢ} [symbol] _{ξ}_{ᵢ}])

Volunteer autonomy failures (Λ) are classified into volunteer volatility failure (Φ) and volunteer interference failure (Ψ).

Λ={Φ, Ψ}

### Definition 1 (Volunteer volatility failure) Volunteer volatility failure Φ is abortion of public execution that is caused by freely leaving of the public execution ξᵢ of a task Γᵢ.

Φ [symbol] T[_{V}_{ᵢ} [symbol] _{ξ}_{ᵢ}] εI₈₆ _{ᵢ}

The volunteer volatility failure is categorized as follows: unexpected-before Φ^{b}, unexpected-middle Φ^{m}, expected Φ^{e}, and unexpected-after Φ^{a}.

Φ={Φ^{b}, Φ^{m}, Φ^{e}, Φ^{a}}

Φ^{b} [symbol] (T[_{V}_{ᵢ} [symbol] _{ξ}_{ᵢ}]εI_{ξ}_{ᵢ}) [symbol] (T[_{V}_{ᵢ} [symbol] _{ξ}_{ᵢ}]<Vᵢ. [symbol] ₛₜ)

φ^{m} [symbol] (T[_{V}_{ᵢ} [symbol] _{ξ}_{ᵢ}]εI_{ξ}_{ᵢ}) [symbol] (Vᵢ. [symbol] ₛₜ<T[_{V}_{ᵢ} [symbol] _{ξ}_{ᵢ}]<Vᵢ. [symbol] ₜₜ)

Φ^{e} [symbol] (T[_{V}_{ᵢ} [symbol] _{ξ}_{ᵢ}]εI_{ξ}_{ᵢ}) [symbol] (T[_{V}_{ᵢ} [symbol] _{ξ}_{ᵢ}]=Vᵢ. [symbol] ₛₜ)

Φ^{a} [symbol] (T[_{V}_{ᵢ} [symbol] _{ξ}_{ᵢ}]εI_{ξ}_{ᵢ}) [symbol] (Vᵢ. [symbol] ₜₜ<T[_{V}_{ᵢ} [symbol] _{ξ}_{ᵢ}])

### Definition 2 (Volunteer interference failure) Volunteer interference failure Ψ is temporary suspension of public execution ξᵢ that is caused by private execution πᵢ of a individual job Πᵢ.

Ψ [symbol] (T[πᵢ]εI_{ξ}_{ᵢ})

Volunteer interference failure Ψ is categorized into expected Ψₑᵢ and unexpected Ψᵤᵢ. Ψₑᵢ occurs when private execution interferes with public execution regularly (e.g. reserved virus checking), but Ψᵤᵢ occurs when private execution that starts from keyboard or mouse movement interferes with public execution irregularly (e.g., temporary email checking etc.). Φ and Ψ are different from crash failure in that the operating system is alive in the presence of Φ and Ψ, whereas it shuts down in the presence of crash failure. Φ is different from crash failure in that Φ occurs by the will of volunteers. Ψ is different from Φ in that a peer-to-peer grid computing system is alive in the presence of Ψ, whereas it is not operating in the case of Φ.

Φ is related to the completion of public execution. For example, if a leave event arbitrarily happens in the middle of public execution, this execution is stopped (or aborted). As a result, the execution is not completed. That is, Φ hinders the completion of execution. On the other hand, Ψ is related to the continuity of public execution. For example, if a personal user frequently performs private execution during public execution, public execution is temporarily suspended. Consequently, the public execution cannot proceed continuously. That is, Ψ obstructs the continuity of execution.

### 2. Mobile Agent based Adaptive Group Scheduling Mechanism

The MAAGSM provides a scheduling mechanism on the basis of volunteer groups. This exploits mobile agents by adaptively applying different scheduling, fault tolerance, and replication algorithms to each volunteer group. In this section, we firstly illustrate how to construct volunteer group according to the properties of volunteers. Then, we introduce how to apply scheduling, fault tolerance, and replication algorithms to volunteer groups by means of mobile agents. Finally, we illustrate how to manage volunteer groups in the case of failures.

### 2.1. Constructing Volunteer Groups

A volunteer group is a set of volunteers that have similar properties such as volunteer autonomy failures, volunteer availability, and volunteering service time. In order to apply different scheduling mechanisms suitable for the properties of volunteers in a scheduling procedure, volunteers are required to first be formed into homogeneous groups. Initially, we classify volunteers according to their properties. Then, we classify and construct volunteer groups.

### 2.1.1 Classifying Volunteers

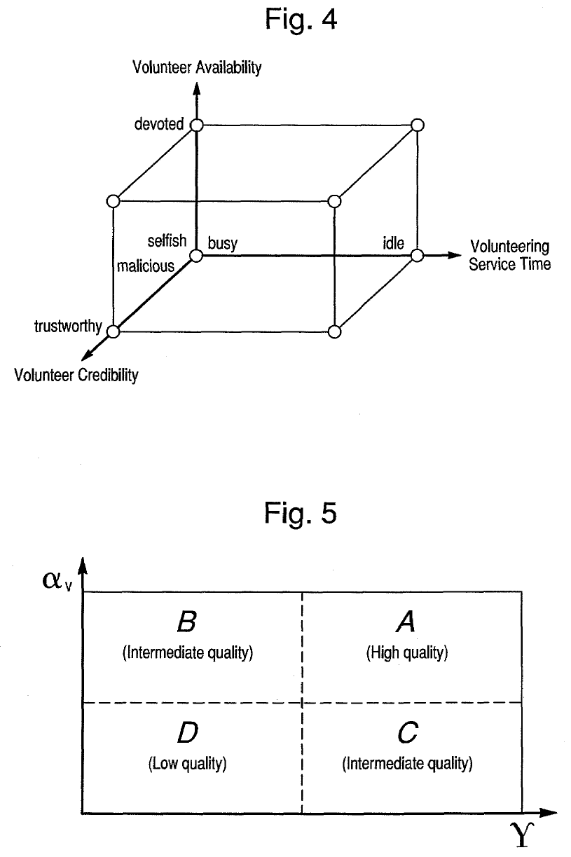

When volunteers are classified, their CPU, memory, storage, and network capacities are important factors. The most important factors, however, are location, volunteering time, volunteer autonomy failures, volunteer availability, and volunteer credibility in the sense that the completion and continuity of computation and the reliability of results are tightly related with volunteering time and availability that result from volatility as well as credibility (see FIG. 4). In a peer-to-peer grid computing environment, the capacities of desktop computers are very similar, whereas the volunteering service time, availability, and credibility fluctuate considerably. In this specification, we concentrate on volunteering service time, volunteer autonomy failures, and volunteer availability when classifying volunteers. This invention is not concerned with the credibility that is related with result certification for detecting and tolerating erroneous results.

The volunteering time and volunteer availability is defined as follows.

### Definition 3 (Volunteering time) Volunteering time (Y) is the period when a volunteer is supposed to donate its resources.

Y=Y_{R}+Y_{S}

Here, the reserved volunteering time (Y_{R}) represents the reserved time when a volunteer provides computing resources. A volunteer mostly performs public execution during Y_{R}, rarely performing private execution. However, the selfish volunteering time (Y_{S}) represents unexpected volunteering time. Thus, a volunteer usually performs private execution during the Y_{S}, and sometimes performs public execution.

### Definition 4 (Volunteer availability) Volunteer availability (aᵥ) is the probability that a volunteer will be correctly operational and be able to deliver the volunteer services during volunteering time Y.

$${α}_{υ} = \frac{MTTVAF}{MTTVAF + MTTR}$$

Here, the MTTVAF represents “mean time to volunteer autonomy failures” and the MTTR represents “mean time to rejoin”. The MTTVAF represents the average time before the volunteer autonomy failures happen, and the MTTR means the mean duration of volunteer autonomy failures. The aᵥ reflects the degree of volunteer autonomy failures, whereas the traditional availability in distributed systems is mainly related with the crash failure.

MTTVAF and MTTR are recalculated dynamically when a volunteer detects Φ and Ψ. Here, MVT represents “mean volunteering time”. The symbol [symbol] represents a combination of the two events. The symbol [symbol] represents the union of time intervals. The parameter μ is a weight constant. When a volunteer executes a task, the μis initially set to 1. The μ increases whenever Φ and Ψ occur. The μ is reset to 1 when the volunteer finishes its task.

$$Case 1 \text{:} {UJ}^{b} , {Φ}^{b} , or {Φ}^{a}$$

$$MTTVAF = MTTVAF + μ \times \frac{\{ {I}_{( {UJ}^{b} ⊳ ⊲ EJ )} ⊎ {I}_{( {UJ}^{b} ⊳ ⊲ {Φ}^{b} )} ⊎ {I}_{( EL ⊳ ⊲ {Φ}^{a} )} \}}{MVT}$$

$$MTTR = MTTR - μ \times \frac{\{ {I}_{( {UJ}^{b} ⊳ ⊲ EJ )} ⊎ {I}_{( {UJ}^{b} ⊳ ⊲ {Φ}^{b} )} ⊎ {I}_{( EL ⊳ ⊲ {Φ}^{a} )} \}}{MVT}$$

$$MVT = MVT + μ \times \frac{\{ {I}_{( {UJ}^{b} ⊳ ⊲ EJ )} ⊎ {I}_{( {UJ}^{b} ⊳ ⊲ {Φ}^{b} )} ⊎ {I}_{( EL ⊳ ⊲ {Φ}^{a} )} \}}{MVT}$$

$$Case 2 \text{:} {UJ}^{m} or {Φ}^{m}$$

$$MTTVAF = MTTVAF - μ \times \frac{\{ {I}_{( EJ ⊳ ⊲ {UJ}^{m} )} ⊎ {I}_{( {Φ}^{m} ⊳ ⊲ EL )} \}}{MVT}$$

$$MTTR = MTTR + μ \times \frac{\{ {I}_{( {Φ}^{m} ⊳ ⊲ {UJ}^{m} )} \}}{MVT}$$

$$MVT = MVT - μ \times \frac{\{ {I}_{( EJ ⊳ ⊲ {UJ}^{m} )} ⊎ {I}_{( {Φ}^{m} ⊳ ⊲ EL )} \}}{MVT}$$

$$Case 3 \text{:} {Ψ}_{ei} or {Ψ}_{ui}$$

$$MTTVAF = MTTVAF - μ \times \frac{\{ {I}_{{Ψ}_{ei}} ⊎ {I}_{{Ψ}_{ui}} \}}{MVT}$$

$$MTTR = MTTR + μ \times \frac{\{ {I}_{{Ψ}_{ei}} ⊎ {I}_{{Ψ}_{ui}} \}}{MVT}$$

$$MVT = MVT - μ \times \frac{\{ {I}_{{Ψ}_{ei}} ⊎ {I}_{{Ψ}_{ui}} \}}{MVT}$$

Cases 1 and 2 describe how to calculate volunteer availability in the case of volunteer volatility failure and unexpected join. Case 3 describes how to calculate volunteer availability when volunteer interference failure occurs. The parameter μ is used in order to reflect the rate of volunteer autonomy failures in volunteer availability. For example, if volunteer autonomy failures occur repeatedly and frequently, volunteer availability drops rapidly. Moreover, the mean volunteering time affects the volunteer availability. For example, if the mean volunteering time is short, volunteer availability is considerably affected by volunteer autonomy failures. In Case 1, volunteer availability increases because unexpected volunteering time is provided. Conversely, in Cases 2 and 3, volunteer availability actually decreases because of volunteer autonomy failures.

Volunteers are categorized into region volunteers or home volunteers according to their location. Home volunteers are defined as resource donators at home. Region volunteers are a set of resource donators that are generally affiliated with organizations including universities, institutions, and so on. Region volunteers are connected to LAN or Intranet, whereas home volunteers are connected to the Internet.

Volunteers are categorized into four classes according to Y and αᵥ (see FIG. 5). The class A is a set of volunteers that have long Y and high αᵥ. The class B is a set of volunteers that have short Y and high αᵥ. The class C is a set of volunteers that have long Y and low αᵥ. The class D is a set of volunteers that have short Y and low αᵥ.

### 2.1.2 Classifying and Making Volunteer Groups

A volunteer server selects volunteers as volunteer group members according to the properties of volunteers such as location, volunteer availability, and volunteering service time. Volunteer service time is defined as follows.

### Definition 5 (Volunteering service time) Volunteering service time (θ) is the expected service time when a volunteer participates in the public execution during Y

Θ=Y×αᵥ

In a scheduling procedure, θ is more appropriate than Y because θ represents the time when a volunteer actually executes each task in the presence of volunteer autonomy failures Λ. Therefore, volunteer groups are constructed according to θ, not Y.

If volunteer groups are constructed on the basis of location, region volunteers belong to the same group, and home volunteers are formed into the same group in order to reduce the communication cost between members.

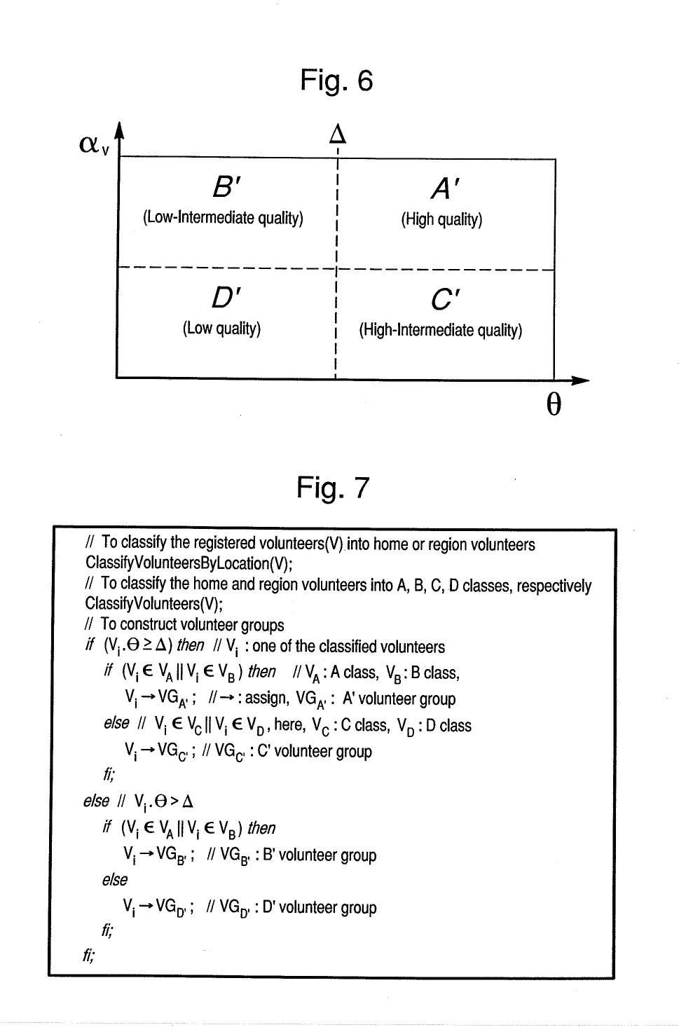

When both αᵥ and θ are considered in grouping the volunteers, the volunteer groups are categorized into four classes (see FIG. 6). Here, Δ is the expected computation time of a task.

Volunteers are classified into four classes: A′, B′, C′, and D′ volunteer groups. If volunteers have a high αᵥ and θ≧Δ, they are included in the class A′. If volunteers have a high αᵥ and θ<Δ, they are included in the class B′. If volunteers have a low αᵥ and θ≧Δ, they are included in the class C′. If volunteers have a low αv and θ<Δ, they are included in the class D′.

Volunteer groups are constructed using the algorithm of volunteer group construction (see FIG. 7).

1) The registered volunteers are classified into home or region volunteers, depending on their location.

2) The home and region volunteers are classified into A, B, C, and D classes by volunteering time and volunteer availability, respectively.

3) The volunteer groups are constructed according to volunteering service time and volunteer availability.

The volunteer groups have the following properties. The A′ volunteer group has a high θ and high αᵥ sufficient to reliably execute tasks. It is used as deputy volunteers that host the scheduling mobile agents. The B′ volunteer group has a high αᵥ, but low θ. It cannot complete their tasks because of lack of computation time. The C′ volunteer group has a high θ, but low αᵥ. It has the time enough to execute tasks. However, volunteer autonomy failures occur frequently during execution. Therefore, it requires fault tolerant mechanism to execute tasks reliably. The D′ volunteer group has a low θ and low αᵥ. It has insufficient time to execute tasks. Moreover, volunteer autonomy failures occur frequently in the middle of execution. Among the volunteer groups, the A′ and C′ volunteer groups mainly execute tasks because of sufficient time. If a task migrates during execution, the B′ volunteer group can be used as migration places when the A′ and C′ volunteer groups suffer from failures. Otherwise, the B′ volunteer group is not appropriate to distribute tasks because its volunteering service time is too short to complete a task. In this case, it executes tasks for testing, that is, to measure its properties. The D′ volunteer group gives rise to a high management cost due to lack of time as well as low volunteer availability. The D′ volunteer group also only executes tasks for testing. If check pointing is used, the B′ and D′ volunteer groups can be used to execute non-time-critical applications.

### 2.1.3 Maintaining Volunteer Groups

The volunteer groups are maintained by three mode: task-based, time-based, and count-based modes. In the task-based mode, whenever a task is completed, volunteer groups are built. The time-based mode builds volunteer groups at the regular intervals if the tasks to schedule remain. The count-based mode constructs volunteers groups when the number of participating volunteers is larger than or equal to a predefined number k. The k depends on the size of volunteer groups or the number of redundancy. The size of a volunteer group is mainly related with the maintenance cost (i.e., the scheduling and management cost of task mobile agents, fault tolerance, replication, etc.). The volunteer groups are kept until the scheduling agent cannot further distribute tasks to members. For example, if all members have insufficient time to execute a task, volunteer groups are dismissed. The members of volunteer groups are partially replaced by others if a volunteer fails (the details are illustrated in subsection 4.3).

### 2.2. Allocating Scheduling Mobile Agents to Scheduling Groups

After constructing volunteer groups, a volunteer server allocates the scheduling mobile agents (S-MA) to volunteer groups. However, it is not practical to allocate S-MAs directly to the volunteer groups in a scheduling procedure because some volunteer groups are not perfect for finishing the tasks reliably. Therefore, it is necessary to build new scheduling groups by combining the volunteer groups with each other (see Table 2).

TABLE 2
The combination of volunteer groups

| | The number of | α_{ν} | Θ | |
|---|---|---|---|---|
| Combination | allocated tasks | compensation | compensation | Description |
| A′D′ & C′B′ | A′D′ ≃ C′B′ or | ◯ | ◯ | The tasks are distributed to each scheduling group. |
| | A′D′ ≧ C′B′ | | | A′ compensates for D′, and C′ compensates for |
| | | | | B′. |
| A′B′ & C′D′ | A′B′ ≃ C′D′ or | X | ◯ | The tasks are distributed to each scheduling group. |
| | A′B′ ≧ C′D′ | | | Both C′ and D′ have low , α_{ν}, so they do not compensate |
| | | | | α_{ν}. |
| A′C′ & B′D′ | A′C′ >>B′D′ | ◯ | X | Tasks are mainly distributed to A′C′. Most tasks |
| | | | | are completed in A′C′. Both B′ and D′ do not |
| | | | | compensate Θ. |

In Table 2, the first two combinations are more appropriate than the last one because the tasks are distributed to each scheduling group in the first two combinations, whereas the tasks are mainly distributed to the A′C′ scheduling group in the last combination. In addition, in the last combination, even though the tasks are allocated to the B′D′ scheduling group, they are not completed due to insufficient time. When comparing the first two combinations, the first combination is more appropriate than the second because the B′ volunteer group is able to compensate for the C′ volunteer group with regard to availability in the first combination, whereas the C′ volunteer group does not compensate for the D′ volunteer group in the second combination. (In the A′D′ or the A′B′ scheduling groups, since the A′ volunteer group has high availability and enough θ, the A′ volunteer group compensates for the D′ and B′ volunteer groups) Therefore, this invention focuses on the first combination in a scheduling procedure.

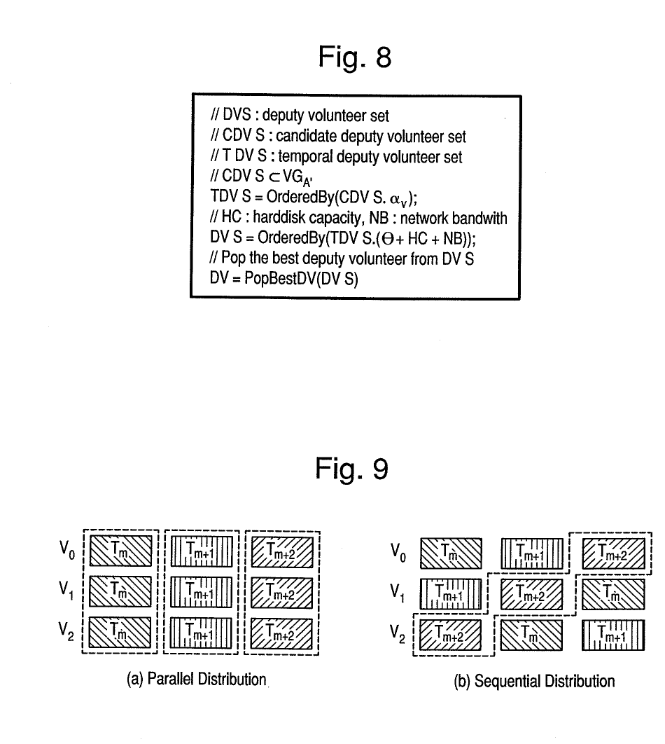

The S-MA is executed at a deputy volunteer. The deputy volunteer is selected using the algorithm (see FIG. 8). The deputy volunteers are ordered by volunteer availability and volunteering service time, and also by hard disk capacity and network bandwidth. Then, the deputy volunteers for scheduling groups are selected sequentially. Next, each S-MA is transmitted to the selected deputy volunteer.

### 2.3. Distributing Task Mobile Agents to Group Members

After the S-MAs are allocated to the scheduling groups, each S-MA distributes the task mobile agents (T-MA) that consist of parallel code and data to the members of the scheduling group. The S-MAs perform different scheduling, fault tolerance, and replication algorithms according to the type of volunteer groups, differently from existing peer-to-peer grid computing systems.

The S-MA of the A′D′ scheduling group performs the scheduling as follows. 1) Order the A′ volunteer group by aᵥ and then by θ. 2) Distribute T-MAs to the arranged members of the A′ volunteer group. 3) If a T-MA fails, replicate the failed task to a new volunteer selected in the A′ volunteer group by means of the replication algorithm, or migrate the task to a volunteer selected in the A′ or B′ volunteer groups if task migration is allowed.

The S-MA of the C′B′ scheduling group performs the scheduling as follows. 1) Order the C′ and B′ volunteer groups by aᵥ and then by θ. 2) Distribute T-MAs to the arranged members of the C′ volunteer group. 3) If a T-MA fails, replicate the failed task to a new volunteer selected in the ordered C′ volunteer groups, or migrate the task to a volunteer selected in the B′ or C′ volunteer groups.

Tasks are firstly distributed to the A′D′ scheduling group and then the C′B′ scheduling group. In addition, the tasks are firstly distributed to the volunteers that have high αᵥ and long θ. In the scheduling algorithm, if checkpointing is not used, tasks are not allocated to the B′ and D′ volunteer groups, because they have insufficient time to finish the task reliably. In this case, the B′ and D′ volunteer groups execute tasks for testing, that is, to measure their properties. For example, the tasks executed in the A′ and C′ volunteer groups are redistributed to the D′ and B′ volunteer groups, respectively. However, the B′ volunteer group can be used to assist the main volunteer groups (i.e., A′ or C′) if task migration is permitted. For example, in the C′B′ scheduling group, the B′ volunteer group can be used to compensate for the C′ volunteer group with regard to volunteer availability. Suppose that a volunteer in the C′ volunteer group suffers from volunteer autonomy failures. If the volunteering time of a volunteer in the B′ volunteer group implies the duration of volunteer autonomy failures at the failed volunteer, the suspended task can migrate to the new volunteer in the B′ volunteer group.

If replication is used, a S-MA calculates the number of redundancy and then selects replicas (i.e., volunteers to execute the replicated computation). Then, the S-MA distributes the T-MAs to the selected replicas. In the case of failures, the S-MA replicates or migrates the failed T-MA to a new volunteer. The replication and fault tolerance algorithms are described in detail, in the 4.4 and 4.5 subsections, respectively.

### 2.4. Applying Adaptive Replication Algorithm

Replication is a well-known technique to improve reliability and performance in distributed systems. In a peer to-peer grid computing environment, replication is mainly used for reliability, that is, to tolerate failures, or for result certification, that is, to detect and tolerate erroneous results. This invention focuses on replication to reliably volunteer autonomy failures. The adaptive replication algorithm automatically adjusts the number of redundancy, and selects an appropriate replica according to the properties of each volunteer group.

### 2.4.1 How to Calculate the Number of Redundancy

If replication is used, each S-MA calculates the number of redundancy to its volunteer group, respectively. It exploits volunteer autonomy failures, volunteer availability, and volunteering service time simultaneously when calculating the number of redundancy.

In a peer-to-peer grid computing environment, volunteer autonomy failures occur much more frequently than crash and link failures. In addition, volunteers have various rates and forms of volunteer autonomy failures. Therefore, the number of redundancy must be calculated on the basis of volunteer groups that have similar rate and form of volunteer autonomy failures in order to reduce the replication overhead. However, existing replication algorithms do not consider a volunteer group based replication algorithm. The adaptive replication algorithm makes use of volunteer autonomy failures, volunteer availability, and volunteering service time as follows.

The number of redundancy r for reliability is calculated using Eq. 1. In this equation, we assume that the lifetime of a system is exponentially distributed. Here, τ represents the MTTVAF of the volunteer, and τ′ represents the MTTVAF of the volunteer group.

(1−e^{-Δ/τ′})^{r}≦1−γ (1)

The parameter γ is the reliability threshold.

τ′=(V₀.τ+V₁.τ+ . . . +Vₙ.τ)/n

Here, n is the total number of volunteers within a volunteer group. The Vₙτ means τ of a volunteer Vₙ.

In Eq. 1, the expression e^{-Δ/τ′} represents the reliability of each volunteer group, which means the probability to complete the tasks within Δ. (If the lifetime of a volunteer is exponentially distributed, then the reliability of the volunteer R(t) is: R(t)=e^{-λ′t}. The parameter λ′ represents the rate of volunteer autonomy failures. If the probability that tasks are completed at time interval Δ is calculated, the e^{-Δ/τ′} is obtained because 1/λ′=τ′) It reflects volunteer autonomy failures. The (1−e^{-Δ/τ′})^{r} means the probability that all replicas fail to complete the replicated tasks.

If the required reliability γ is provided, the value of r is calculated using Eq. 1. Each volunteer group has different r. For example, the A′ and C′ volunteer groups have smaller r than the B′ volunteer group.

### 2.4.2 How to Distribute T-MAs to Replicas

The methods of distributing tasks to replicas are categorized into two approaches: parallel distribution and sequential distribution (see FIG. 9).

In FIG. 9, the replicas consist of volunteers, V₀, V₁, and V₂ (that is, r=3). In the parallel distribution, the task Tₘ is distributed to all members at the same time in FIG. 9 (a), and then executed simultaneously. Conversely, the task Tₘ is distributed and then executed sequentially in FIG. 9(b).

In the case of the A′ volunteer group, sequential distribution is more appropriate than parallel distribution because the former can complete more tasks. For example, in FIG. 9(b), if V₀ completes the task Tₘ, there is no need to execute it at V₁ and V₂. The A′ volunteer group has a high possibility of executing a task reliably without failures (especially, volunteer autonomy failures) because of high volunteer availability. However, if the A′ volunteer group performs parallel distribution in FIG. 9(a), it exhibits the overhead of replication in the sense that the volunteers execute the same tasks even though they are able to execute other tasks. In contrast to the A′ volunteer group, in the case of the C′ volunteer group, sequential distribution is more appropriate than parallel because the C′ volunteer group frequently suffers from volunteer autonomy failures owing to a low αᵥ.

### 2.5. Handling Failures

Volunteer autonomy failures lead to the delay and blocking of the execution of tasks. They occur much more frequently than crash and link failures in a peer-to-peer grid computing environment. Moreover, volunteers take various occurrence rates and forms of volunteer autonomy failures. A peer-to-peer grid system is required to conduct various fault tolerance algorithms in scheduling procedures according to the occurrence rate and form. To achieve this, we apply different fault tolerance algorithms according to the property of each volunteer group, while also distinguishing volunteer autonomy failures from the traditional failures. We describe how the scheduling and task mobile agents work in the presence of failures in this subsection.

The volunteer autonomy failures Φ are different from crash failure in that the operating system is alive in spite of volunteer volatility failure Φ and volunteer interference failure Ψ, whereas it shuts down in the presence of crash failure. Φ is different from crash failure in that Φ occurs due to the request of volunteers. Ψ is different from Φ in that a peer-to-peer grid computing system is alive in spite of Ψ, whereas it is not operating in the case of Φ.

The volunteer server detects the crash failure of S-MA using a timeout. Similarly, the S-MA detects the crash failure of T-MA. To achieve this, the S-MA sends alive messages to its volunteer server. Similarly, the T-MA sends alive messages to the S-MA. The T-MAs in the D′ volunteer group do not send alive messages, in order to reduce the management overhead. A volunteer can detect volunteer autonomy failures by oneself because its operating system does not shut down. If T-MA or S-MA detects the volunteer autonomy failures, it notifies its S-MA or volunteer server, respectively.

### 2.5.1 Failure of S-MA

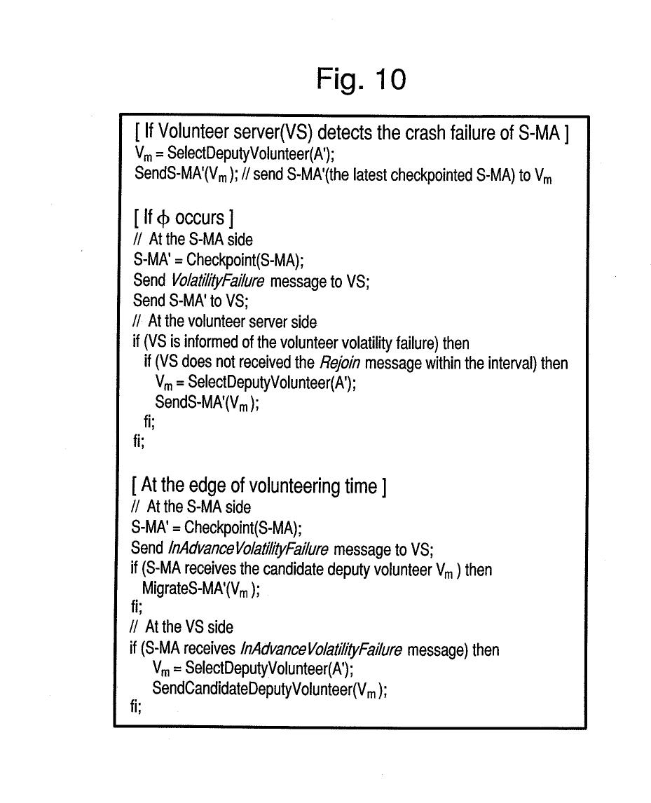

A S-MA rarely suffers from volunteer autonomy failures because it is executed at the deputy volunteers that are selected among the A′ volunteer group. The S-MA stores information such as scheduling group lists, scheduling table, and task results in a stable storage. If the S-MA fails, the information is sent to a new deputy volunteer. FIG. 10 shows the fault tolerant algorithm of S-MA.

If a volunteer server detects the crash failure of S-MA, the new deputy volunteer is selected by the algorithm of deputy volunteer selection presented in FIG. 8. Next, the S-MA and the scheduling information are sent to the newly selected deputy volunteer. If a S-MA suffers from the volunteer volatility failure, it sends a VolatilityFailure message to the volunteer server. If the S-MA joins again during the volunteering time, it sends Rejoin message to its volunteer server. If the volunteer server does not receive a Rejoin message within the interval after receiving a VolatilityFailure message, it sends the S-MA to a new deputy volunteer.

If a S-MA is at the edge of reserved volunteering time, it sends an InAdvanceVolatilityFailure message to its volunteer server. In this case, the volunteer server responds with a candidate deputy volunteer. The S-MA migrates to the candidate deputy volunteer.

In the case of volunteer interference failure, a S-MA does not take any action because it can perform scheduling procedures in the sense that the peer-to-peer grid system is alive.

### 2.5.2 Failure of T-MA

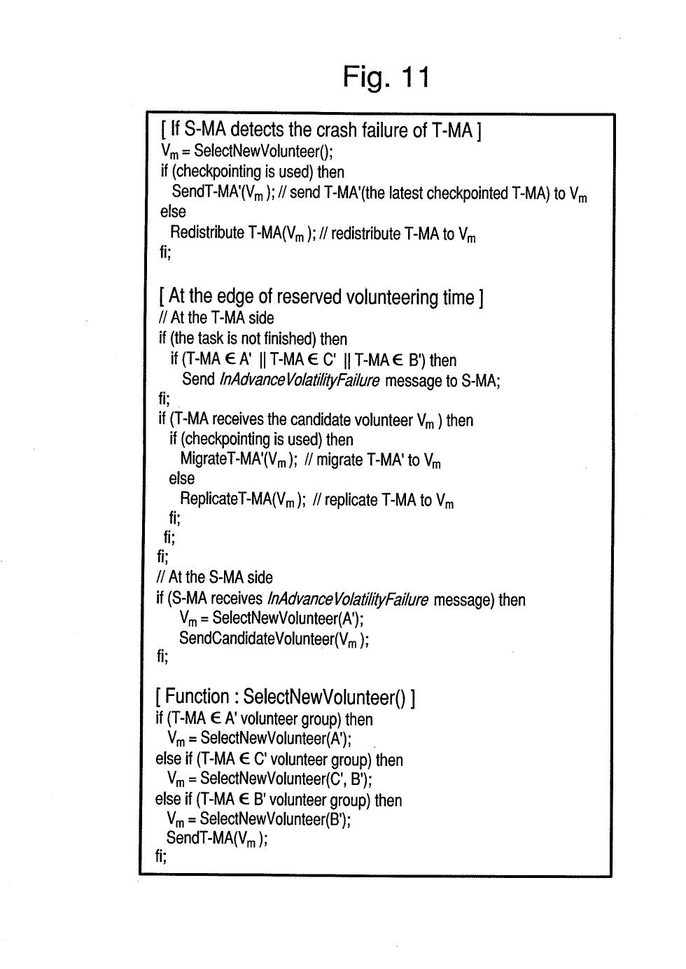

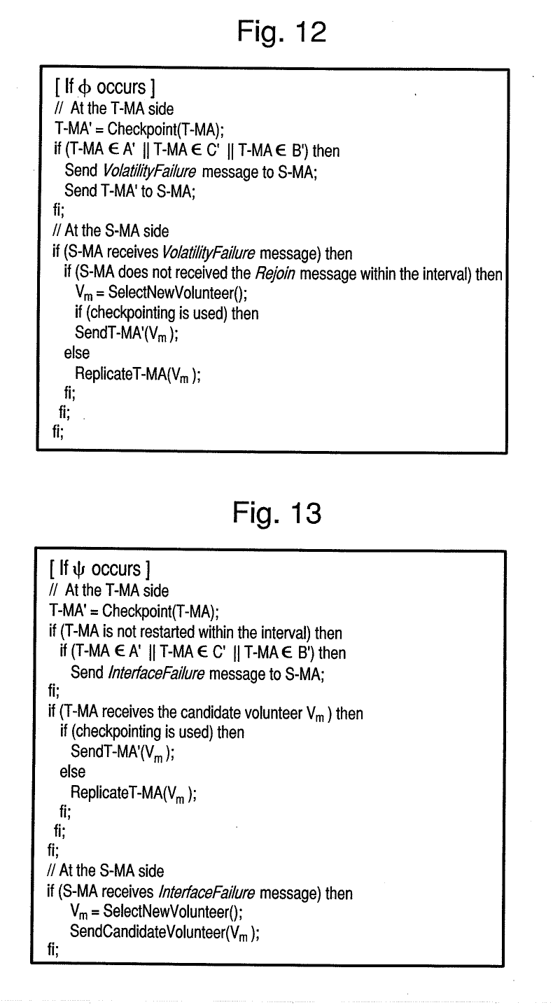

A T-MA suffers from volunteer autonomy failures more frequently than a S-MA, because it has relatively low availability. The T-MA checkpoints the execution state at the rate of MTTVAF if checkpointing is used. FIGS. 11, 12, and 13 show the fault tolerant algorithm of T-MA.

If a S-MA detects the crash failure of T-MA, it selects a new volunteer. If checkpointing is used, the S-MA sends the latest checkpointed T-MA′ to it. Otherwise, the S-MA redistributes the T-MA to the new one. Each S-MA redistributes the T-MA within the number of redundancy r.

If a T-MA is at the edge of reserved volunteering time, it sends a InAdvanceVolatilityFailure message to its S-MA. After receiving a candidate volunteer, it migrates to the candidate volunteer or is replicated.

If a T-MA suffers from volunteer volatility failure Φ, it takes a checkpoint of the execution of task and then notifies its S-MA of Φ by means of a Volatility Failure message. Next, if the S-MA does not receive any Rejoin message from the failed volunteers within predefined time interval, it reschedules the T-MA. If checkpointing and migration are used, the S-MA migrates the T-MA′ to a new volunteer. Otherwise, the S-MA replicates the T-MA by the number of redundancy r.

If a T-MA suffers from volunteer interference failure Ψ, it takes a checkpoint of the execution. Then, if the execution is not restarted within the interval, the volunteer sends an InterferenceFailure message to its S-MA. After receiving a candidate volunteer, the T-MA migrates to the candidate volunteer or is replicated.

In the algorithm, there is no fault tolerant mechanism for the D′ volunteer group in the presence of failures during the execution in order to reduce management overhead. The D′ volunteer group executes the task for testing, for example, for the purpose of recalculating volunteer autonomy failures, volunteer availability, and volunteering service time.

### 3. Implementation & Evaluation

### 3.1. Implementation

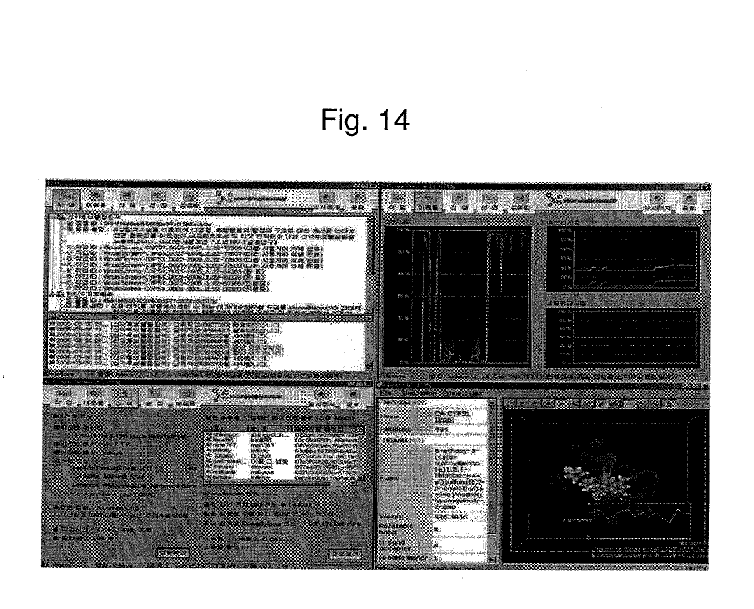

We implemented the adaptive scheduling mechanism of the present invention on the basis of the “Korea@Home” and “ODDUGI” mobile agent system. The Korea@Home project attempts to harness the massive computing power of the great numbers of PCs distributed over the Internet 4. In addition, the ODDUGI developed by the inventors of the present invention is a mobile agent system supporting reliable, secure, and fault tolerant execution of mobile agents. FIG. 14 presents an execution screen shots in Korea@Home.

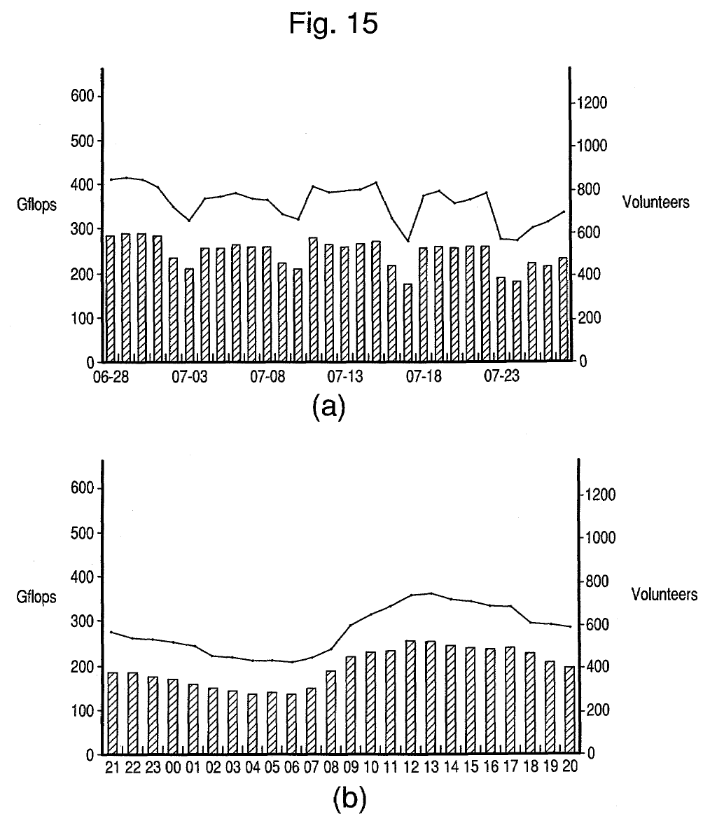

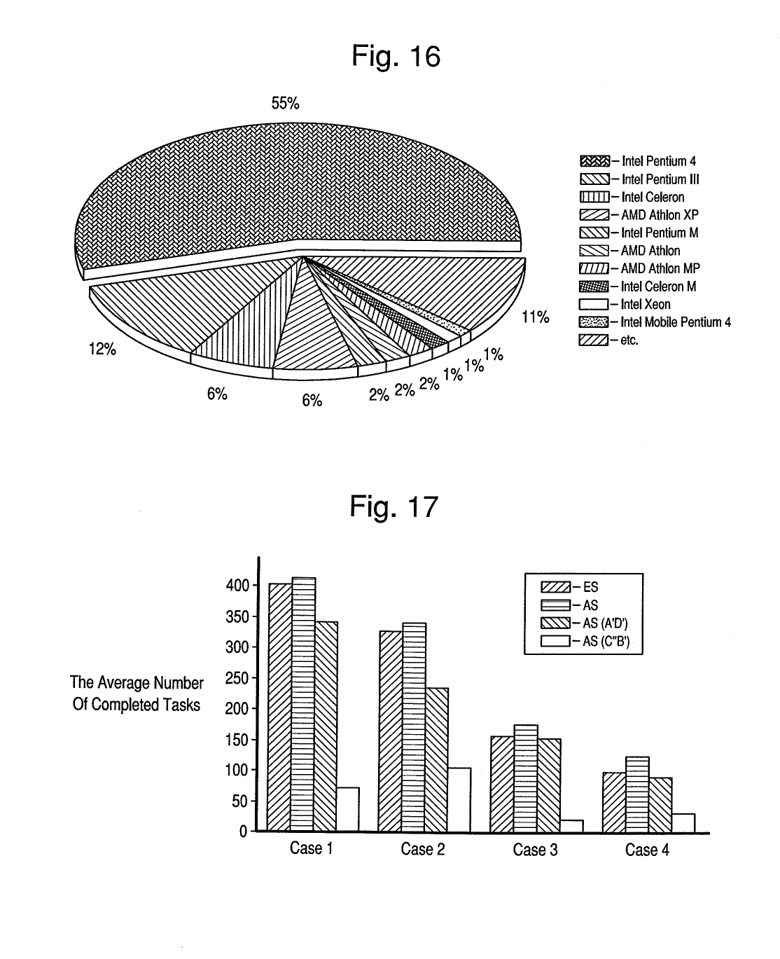

Now, the Korea@Home has 6,744 volunteers and 524 of them are active on average. We conducted performance measurements over one month (i.e., July 2005). FIGS. 15(a) and (b) show daily performance (412.43 Gflops at maximum and 352.46 Gflops on average) and hourly performance (356.53 Gflops at maximum and 265.09 Gflops on average), respectively. In Korea@Home, volunteers can take part in one of three kinds of applications: global risk management, new drug candidate discovery, and climate prediction. The CPU types of volunteers are somewhat various, but the majority demonstrates similar CPU performance. For example, the Intel Pentium 4 consists of approximately 55% of the total, the Pentium III represents approximately 12%, the Celeron represents approximately 6%, and so on (see FIG. 16).

### 3.2. Evaluation

We evaluate our MAAGSM with existing scheduling mechanisms. The evaluation focuses on how much performance improvement is achieved, depending on whether volunteer groups are considered in a scheduling procedure. To this end, volunteer groups were intentionally set up, which have different volunteering service time θ and volunteer availability αᵥ.

We compare our adaptive scheduling mechanism with eager scheduling. In eager scheduling, a volunteer asks its volunteer server of a new task as soon as it finishes its current task. As a result, the more eager a volunteer works, the more tasks are executed. There are a lot of scheduling heuristics in grid computing environments, e.g., MCT, MET, SA, KPB, min-min, max-min, and sufferage heuristics. We adopt eager scheduling among existing scheduling heuristics because it is more straightforward and simple than other heuristics in grid computing. In particular, the eager scheduling has been used mainly in dynamic peer-to-peer grid computing environments because it is more adaptive to dynamic environments than heuristics in grid computing.

We make use of a simulation to evaluate the MAAGSM. The simulation was conducted with real volunteers in Korea@Home. The application was new drug candidate discovery. A task in the application consumes 16 minutes of execution time on a dedicated Pentium 1.4 GHz. Table 3 presents the simulation environment with different volunteer groups, volunteering service time, and volunteer availability. For each case in Table 3, 200 volunteers participated in the simulation during one hour. In Case 1, the A′ volunteer group has more volunteers than the other groups. Case 2 shows that more volunteers belong to the A′ and C′ volunteer groups when compared to the other groups. In Case 3, the A′ and B′ volunteer groups have more volunteers than the other groups. In Case 4, the D′ volunteer group has more volunteers than the other groups. When analyzing Table 3, it can be observed that Case 1 has larger volunteer availability and volunteering service time than the other cases. Case 4 has smaller volunteer availability and volunteering service time than the other cases. Based on this simulation environment, the simulation is conducted 10 times per each case.

As shown in Table 3, the 200 volunteers have various volunteer autonomy failures, volunteer availability, and volunteering service time. We assume that the range of MTTVAF is 1/0.2˜1/0.02 minutes and MTTR is 3˜10 minutes. The simulation used the number of completed tasks and the number of redundancy as the performance metrics. In addition, we measured the number of completed tasks depending on whether replication was applied or not. We measured two performance metrics on the basis of scheduling groups (i.e., A′D′ and C′B′).

TABLE 3
Simulation Environment

| Case | | A′ | B′ | C′ | D′ | Total |
|---|---|---|---|---|---|---|
| Case 1 | # of | 127 (63%) | 30 (15%) | 35 (17%) | 9 (5%) | 200 |
| | vol. | | | | | |
| | α_{ν} | 0.95 | 0.95 | 0.74 | 0.77 | 0.91 |
| | Θ | 43 | 15 | 31 | 11 | 35 min. |
| Case 2 | # of | 95 (47%) | 26 (13%) | 63 (32%) | 16 (8%) | 200 |
| | vol | | | | | |
| | α_{ν} | 0.9 | 0.9 | 0.65 | 0.65 | 0.80 |
| | Θ | 40 | 14 | 28 | 9 | 30 min. |
| Case 3 | # of | 78 (39%) | 75 (37%) | 16 (8%) | 31 (16%) | 200 |
| | vol | | | | | |
| | α_{ν} | 0.95 | 0.95 | 0.70 | 0.61 | 0.88 |
| | Θ | 31 | 11 | 25 | 8 | 20 min. |
| Case 4 | # of | 52 (26%) | 48 (24%) | 23 (12%) | 77 (38%) | 200 |
| | vol | | | | | |
| | α_{ν} | 0.85 | 0.85 | 0.56 | 0.54 | 0.70 |
| | Θ | 28 | 9 | 22 | 7 | 15 min. |

# of vol.: the number of volunteers

FIG. 17 presents the average number of completed tasks. In FIG. 17, ES and AS represent existing eager scheduling and the MAAGSM, respectively. In addition, AS(A′D′) and AS(C′B′) represent each scheduling group in the MAAGSM (Note that the sum of AS(A′D′) and AS(C′B′) is equal to AS). As presented in FIG. 17, the MAAGSM completes more tasks than the existing eager scheduling method. The obtained results indicate the following factors. First, the A′ volunteer group has an important role in gaining better performance. When the number of members in the A′ volunteer group decreases gradually(i.e., from Case 1 to Case 4), the number of completed tasks also decreases. Second, the number of members of the A′ and C′ volunteer groups is more important than that of the B′ and D′ volunteer groups. For example, Cases 1 and 2 have more completed tasks than Cases 3 and 4. Third, volunteer availability is tightly related with performance improvement. For instance, Case 1 with the highest volunteer availability has completed many tasks than the other cases. On the other hand, the completed tasks of Case 4 with the lowest volunteer availability are less than those of the other cases. Finally, as the number of members in the A′ volunteer group gradually decreases and the number of members in the B′ and D′ volunteer groups increases, the difference between the MAAGSM and the eager scheduling increases. This result is anticipated in the sense that, in the eager scheduling, the failed or suspended tasks in A′, B′, C′, or D′ volunteer groups are redistributed to low quality volunteers interchangeably. On the other hand, since the MAAGSM performs scheduling on a per group basis, the undesired situation does not happen. For example, the failed or suspended tasks in the C′ volunteer groups are not distributed to the B′ and D′ volunteer groups. The difference in Case 1 is smaller than other cases because there are more members of the A′ volunteer group than other groups. In other words, the undesired situations rarely occur in Case 1.

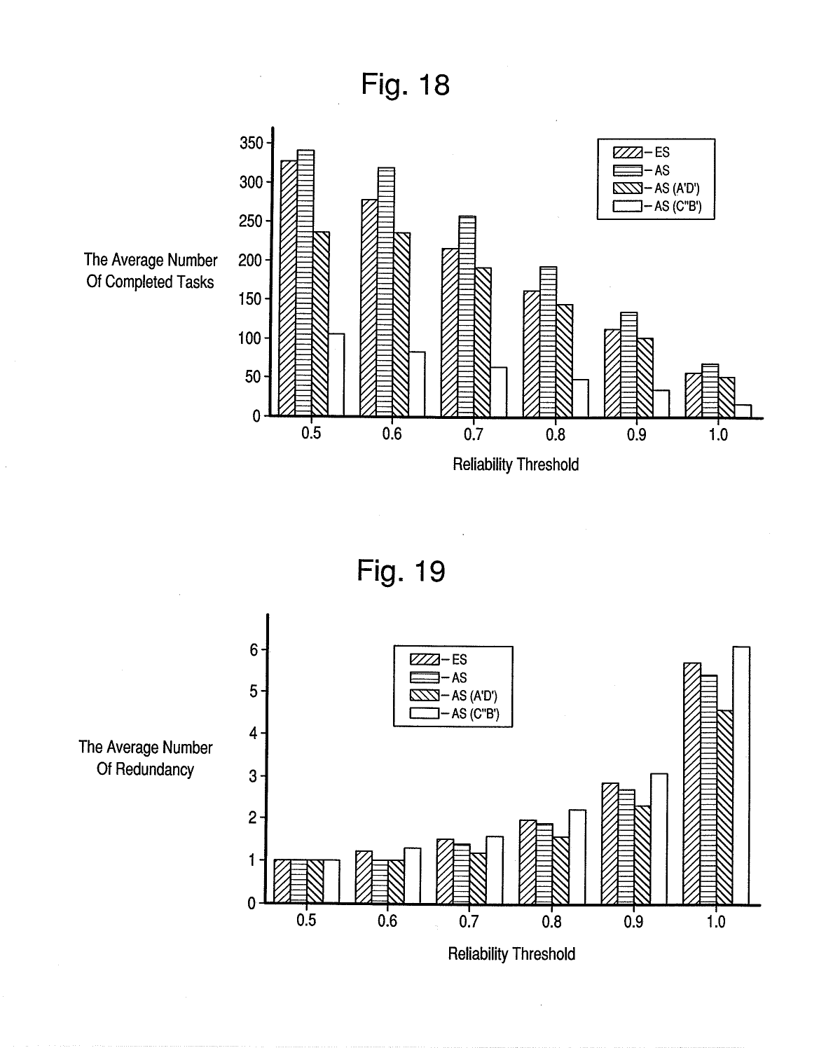

FIG. 18 presents the average number of completed tasks when replication is used to tolerate volunteer autonomy failures for Case 2. In FIG. 18, the tick value 1.0 on the x-axis actually represents 0.99 (refer to Eq. 1). From this figure, as the reliability threshold increases, the number of completed tasks decreases. The obtained results indicate that more tasks should be replicated to support higher reliability.

FIG. 19 presents the number of redundancy r for Case 2. The MAAGSM has a smaller r than the eager scheduling because the scheduling mobile agent applies the replication algorithm to each volunteer group. That is, it adaptively adjusts the number of redundancy r according to the rate of volunteer autonomy failures of volunteer groups. In addition, the A′D′ scheduling group has a smaller r than the C′B′ scheduling group because the A′ volunteer group has higher volunteer availability and volunteering service time than the C′ volunteer group. Since the C′ volunteer group suffers from volunteer autonomy failures more frequently than the A′ volunteer group, the former has a greater r than the latter. Therefore, in the case of the A′ volunteer group, the small r satisfies the reliability threshold. In the case of the C′ volunteer group, the large r is required to meet the reliability threshold. As a result, the A′ volunteer group can execute more tasks because it can reduce replication overhead. Finally, as the reliability is increasingly required, the number of redundancy r increases.

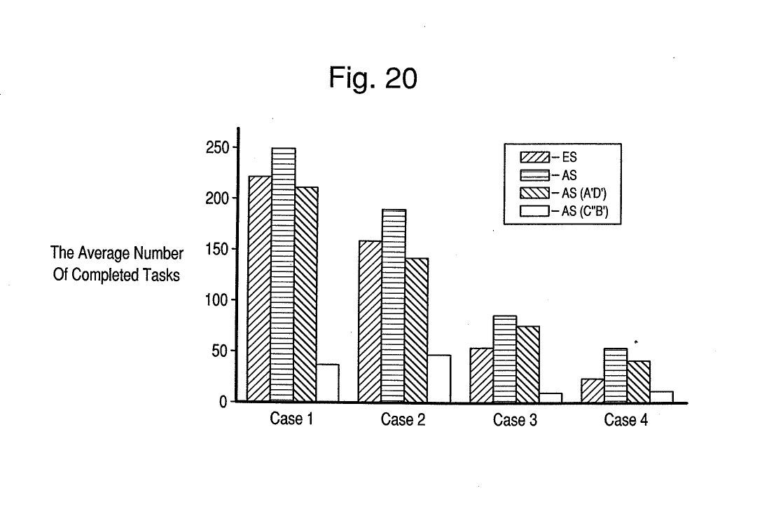

FIG. 20 presents the average number of completed tasks in the case of replication. In FIG. 20, the value of 0.8 is used as the reliability threshold. When compared to FIG. 17, the difference between the MAAGSM and the eager scheduling is larger. In the MAAGSM, the A′ volunteer group can complete more tasks, because it has a relatively small r. On the other hand, the eager scheduling does not consider a homogeneous group, so the following undesirable situation occurs repeatedly. Suppose that a volunteer in the C′ volunteer group suffers from volunteer autonomy failures. In this case, its failed task should be distributed to a new volunteer. In the eager scheduling, the new volunteer is selected without considering volunteer groups. If the newly selected volunteer belongs to the B′ or D′ volunteer groups, it would also fail because of the high rate of volunteer autonomy failures. If volunteers with low quality are selected continuously, the task is continuously redistributed to other volunteers until a high quality volunteer is chosen. Such an undesirable situation occurs frequently and repeatedly if there are a lot of volunteers belonging to the B′, C′, or D′ volunteer groups. Thus, the difference between the MAAGSM and the eager scheduling in the Cases 3 and 4 is larger than that in Cases 1 and 2.

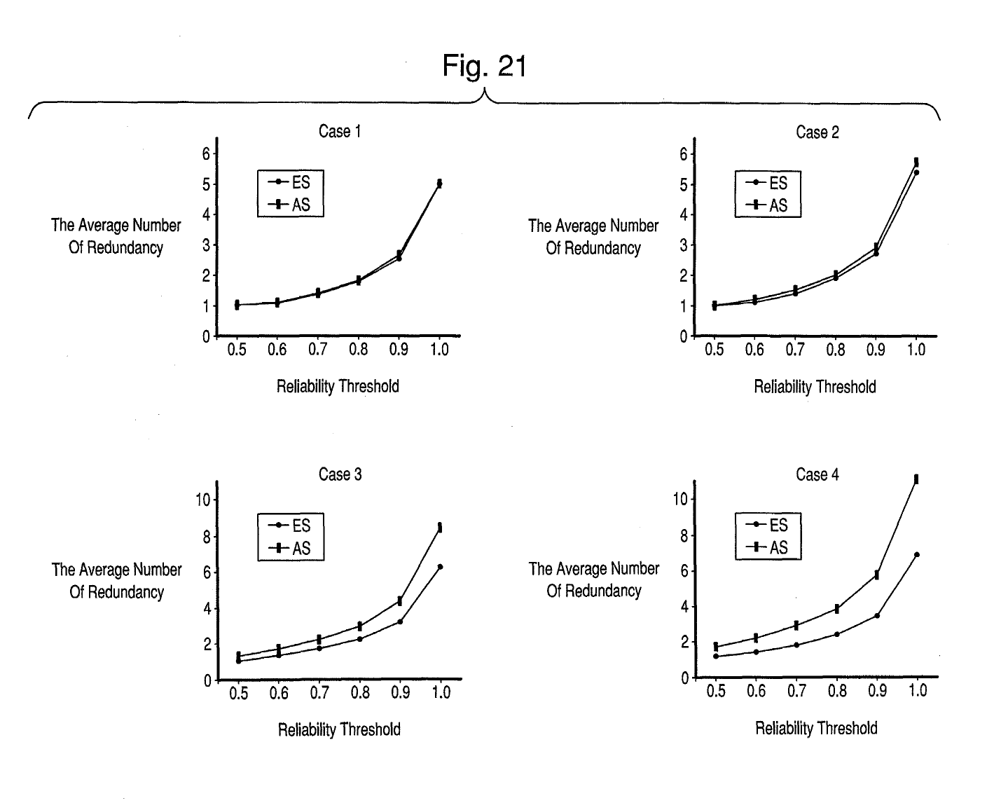

FIG. 21 presents the number of redundancy r for all cases. As the number of members in A′ volunteer group decreases, the difference between the MAAGSM and the eager scheduling increases. For example, Case 1 has the largest A′ volunteer group, therefore, the number of redundancy r of the MAAGSM is similar to that of eager scheduling. Since Case 2 has many members of the A′ and C′ volunteer groups, the gap between the MAAGSM and the eager scheduling is larger than that shown in Case 1. Similar results are presented in Cases 3 and 4. Compared with the eager scheduling, the MAAGSM has a small r because the MAAGSM calculates the number of redundancy on the basis of volunteer groups, in contrast to eager scheduling. In the MAAGSM, volunteer groups with a high rate of volunteer autonomy failures require a large r, and vice versa. Consequently, the MAAGSM completes more tasks than the eager scheduling. A′ volunteer group can complete more tasks because it has a smaller number of redundancy than the eager scheduling as presented in FIG. 21.

We claim:

1. In a computer network including a volunteer server, a plurality of volunteers and a client which submits a job to the volunteer server, a method of peer-to-peer grid computing based on mobile agents, comprising steps of:
registering properties of volunteers and classifying them into a plurality of volunteer groups according to their properties;
dividing the submitted job into a number of tasks, each task being implemented as a task mobile agent;
assigning scheduling mobile agents to the volunteer groups according to their properties;
each scheduling mobile agents distributing the task mobile agents to the members of its volunteer group;
each volunteer executing the task mobile agent in cooperation with its scheduling mobile agent;
each task mobile agent returning result of the execution to its scheduling mobile agent;
scheduling mobile agents aggregating the results and returning the collected results to the volunteer server; and
the volunteer server returning a final result to the client.

2. The method of claim 1, wherein the properties of the volunteers includes CPU, memory capacity, storage, and network capacity.

3. The method of claim 1, wherein the properties of the volunteers includes volunteering service time which is the expected service time when a volunteer participates in the public execution and volunteer availability which is the probability that a volunteer will be correctly operational and be able to deliver the volunteer services.

4. The method of claim 3, wherein the properties of the volunteers further includes location of the volunteers.

5. The method of claim 4, wherein volunteer groups are constructed by:
classifying the registered volunteers into home or region volunteers depending on their location wherein home volunteers are connected to the Internet and region volunteers are connected to LAN or Intranet;
classifying the home and region volunteers into A′, B′, C′ and D′ classes by volunteering service time and volunteer availability, wherein class A′ is a set of volunteers with long volunteering service time and high volunteering availability, class B′ is a set of volunteers with short volunteering service time and high volunteering availability, class C′ is a set of volunteers with long volunteering service time and low volunteering availability, and class D′ is a set of volunteers with short volunteering service time and low volunteering availability.

6. The method of claim 5, wherein volunteer availability is calculated by MTTVAF/(MTTVAF+MTTR), where MTTVAF represents mean time to volunteer autonomy failures and MTTR represents mean time to rejoin.

7. The method of claim 5, wherein volunteer groups of class A′ and class C′ are combined to build scheduling groups of class A′C′ and tasks are distributed to the A′C′ scheduling groups.

8. The method of claim 5, wherein volunteer groups of class A′ and class D′ are combined to build A′D′ scheduling groups and volunteer groups of class C′ and class B′ are combined to build scheduling groups of class C′ B′, and tasks are firstly distributed to A′D′ scheduling groups and then the C′B′ scheduling groups.

9. The method of claim 8, wherein the scheduling mobile agent of the A′D′ scheduling group performs the scheduling as follows: 1) order the A′ volunteer group by volunteer availability and then by volunteering service time, 2) distribute task mobile agents to the arranged members of the A′ volunteer group, 3) if a task mobile agent fails, replicate the failed task to a new volunteer selected in the A′ volunteer group.

10. The method of claim 8, wherein the scheduling mobile agent of the C′B′ scheduling group performs the scheduling as follows: 1) order the C′ and B′ volunteer groups by volunteer availability and then by volunteering service time, 2) distribute task mobile agents to the arranged members of the C′ volunteer group, 3) if a task mobile agent fails, replicate the failed task to a new volunteer selected in the B′ or C′ volunteer groups.

11. The method of claim 8, wherein tasks are firstly distributed to the A′D′ scheduling group and then the C′B′ scheduling group.

12. The method of claim 5, wherein the step of classifying the home and region volunteers into A′, B′, C′ and D′ classes includes the steps of:
classifying the home and region volunteers into A, B, C and D classes by volunteering time and volunteer availability, wherein class A is a set of volunteers with long volunteering time and high volunteering availability, class B is a set of volunteers with short volunteering time and high volunteering availability, class C is a set of volunteers with long volunteering time and low volunteering availability, and class D is a set of volunteers with short volunteering time and low volunteering availability;
if volunteering service time of a volunteer is equal or larger than the expected computation time of a task, classifying the volunteer as class A′ if the volunteer belongs to class A or B, otherwise classifying the volunteer as class C′; and
if volunteering service time of a volunteer is less than the expected computation time of a task, classifying the volunteer as class B′ if the volunteer belongs to class A or B, otherwise classifying the volunteer as class D′.

13. The method of claim 5, wherein volunteer groups of class A′ and class B′ are combined to build A′B′ scheduling groups and volunteer groups of class C′ and class D′ are combined to build scheduling groups of class C′D′, and tasks are distributed to each scheduling group.

14. The method of claim 5, wherein the step of assigning scheduling mobile agents to volunteer groups includes:
designate volunteers with class A′ as candidate deputy volunteers;
ordering the candidate deputy volunteers by volunteer availability, volunteering service time, hard disk capacity and network bandwidth;
selecting required number of deputy volunteers from the ordered candidate deputy volunteers sequentially; and
transmitting each scheduling mobile agent to each of the selected deputy volunteers.

15. The method of claim 14, each scheduling agent stores scheduling information including scheduling group lists, a scheduling table, and task results.

16. The method of claim 15, wherein the method further comprises the steps of:
the scheduling mobile agents sending alive messages to the volunteer server periodically;
the volunteer server selecting a new deputy volunteer when the alive messages are missing for a predetermined time from a scheduling mobile agent; and
the volunteer server sending the scheduling mobile agent and the scheduling information to the new deputy volunteer.

17. The method of claim 14, wherein the method further comprises the steps of:
the task mobile agents sending alive messages to its scheduling mobile agent periodically;
the scheduling mobile agent selecting a volunteer when the alive messages are missing for a predetermined time from a task mobile agent; and
the scheduling mobile agent sending the task mobile agent to the new volunteer.

18. The method of claim 14, wherein the method further comprises the steps of:
the scheduling mobile agent sending an In-advance Volatility Failure message to the volunteer server when it is at the edge of reserved volunteering time;
the volunteer server responding with a candidate deputy volunteer; and
the scheduling mobile agent migrating to the candidate deputy volunteer.

19. The method of claim 14, wherein the method further comprises the steps of:
the task mobile agent sending an In-advance Volatility Failure message to the its scheduling mobile agent when it is at the edge of reserved volunteering time;
the scheduling mobile agent responding with a candidate volunteer; and
the task mobile agent migrating to the candidate volunteer.

20. The method of claim 14, wherein the method further comprises the steps of:
if a task mobile agent suffers from volunteer volatility failure, the task mobile agent taking a checkpoint of the execution of task and notifying its scheduling mobile agent of volunteer volatility failure by means of a Volatility Failure message; and
the scheduling mobile agent rescheduling the task mobile agent if it does not receive any rejoin message from the failed volunteer within predetermined time interval.

21. The method of claim 20, wherein the step of rescheduling includes the step of:
the scheduling mobile agent migrating the latest check pointed task mobile agent to a new volunteer.

22. The method of claim 14, wherein the method further comprises the steps of:
if a task mobile agent suffers from volunteer interference failure, the task mobile agent taking a checkpoint of the execution of task;
the volunteer sending an Interference Failure message to its scheduling mobile agent if the execution is not restarted within predetermined time interval;
the scheduling mobile agent responding with a candidate volunteer; and
the task mobile agent migrating to the candidate volunteer.

23. The method of claim 1, wherein the method further comprises the steps of:
if a task mobile agent fails, the scheduling mobile agent calculating the number of redundancy to its volunteer group;
the scheduling mobile agent selecting volunteers according to the properties of the volunteer group; and
the scheduling mobile agent distributing the task mobile agent to the selected volunteers.

24. The method of claim 23, wherein the redundancy r is calculated using the following equation:
(1−e^{-Δ/τ′})^{r}≦1−γ
where γ is the required reliability, τ′ represents the mean time to volunteer autonomy failures and Δ is the expected computation time of a task.

25. The method of claim 23, wherein the step of distributing the task mobile agent to the selected volunteers includes distributing the task mobile agent to all the selected volunteers at the same time and the executing the task mobile agents simultaneously.

26. The method of claim 23, wherein the step of distributing the task mobile agent to the selected volunteers includes distributing the task mobile agent and executing it sequentially.
